(19) United States
(12) Patent Application Publication
(10) Pub. No.: US 2009/0256819 A1
(43) Pub. Date: Oct. 15, 2009

(54) DISPLAY PANEL ASSEMBLY AND DISPLAY APPARATUS HAVING THE DISPLAY PANEL ASSEMBLY

(76) Inventor: Myung-Sook JUNG, Gyeonggi-do (KR)

Correspondence Address: Haynes and Boone, LLP;IP Section, 2323 Victory Avenue, SUITE 700, Dallas, TX, 75219, US

(21) Appl. No.: 12/408,956

(22) Filed: Mar. 23, 2009

(30) Foreign Application Priority Data
Apr. 11, 2008 (KR) 10-2008-0033727

(51) Int. Cl. G06F 3/044; G06F 3/041; G06F 3/045

(52) U.S. Cl. 345/174; 345/173

(57) ABSTRACT

A display panel assembly according to one or more embodiments includes a display panel and a protective film. The display panel converts information input by physical pressure into an electric signal and displays an image. The protective film includes a base disposed on the display panel and a protruding part protruding from a surface of the base facing the display panel. The protective film transfers the physical pressure from the exterior to the display panel.

### PRIORITY STATEMENT

This application claims priority to and benefit from Korean Patent Application No. 2008-33727, filed on Apr. 11, 2008 in the Korean Intellectual Property Office (KIPO), the contents of which are incorporated herein by reference in their entirety.

### BACKGROUND

1. Technical Field

Embodiments of the present invention relate to a display panel assembly and a display apparatus. More particularly, embodiments of the present invention relate to a display panel assembly receiving information input by a physical pressure and a display apparatus having the display panel assembly.

2. Description of the Related Art

During the information age, a display apparatus has been developed to process a great amount of information and to display images. Particularly, a liquid crystal display (LCD) of the display apparatus has been developed to meet a user's requirements for a display apparatus which is thin and light, and consumes low power.

The LCD displays the image using properties of liquid crystal molecules, such as an optical anisotropy of the liquid crystal molecules, a polarization of the liquid crystal molecules, etc. The liquid crystal molecules have a thin, long molecular structure. When an electric field is applied to the liquid crystal molecules, an arrangement of the liquid crystal molecules is changed so that the amount of light passing through the liquid crystal molecules may be controlled. The LCD displays the image using the properties of the liquid crystal molecules discussed above.

A touch screen panel is a new information input method which may replace methods in which information is input by a mouse, a keyboard, etc. In the touch screen panel, the information is input by directly touching a screen using a finger or a pen. Since the touch screen panel easily receives the information, the touch screen panel is regarded as an ideal information input method and may be employed by a portable telephone, a personal digital assistant, a banking device, etc.

The touch screen panel includes a resistive type and a capacitive type. In the touch screen panel, a touch sensor is disposed between an upper substrate and a lower substrate. The upper substrate displays an image and serves as a touch region. The lower substrate is opposite to the upper substrate. When a physical pressure is applied to the touch region, the upper substrate is bent toward the lower substrate. Then, the touch sensor senses the information concerning the position at which the physical pressure is applied and analyzes the information.

Generally, a hard protective film formed of, for example, glass is disposed on the upper substrate to protect the upper substrate. When the hard protective film is disposed on the upper substrate, the touch sensor may sensitively detect the physical pressure.

### SUMMARY

Embodiments of the present invention provide a display panel assembly capable of sensitively detecting a physical pressure and having improved durability.

Embodiments of the present invention also provide a display apparatus having the display panel assembly.

According to an embodiment of the present invention, there is provided a display panel assembly. The display panel assembly includes a display panel and a protective film. The display panel converts information input by a physical pressure into an electric signal and displays an image. The protective film includes a base disposed on the display panel and a protruding part protruding from a surface of the base facing the display panel and transfers the physical pressure from the exterior to the display panel.

The base may include a transparent plastic material and may have a plate shape. The base may cover the display area of the display panel.

The protruding part may include a plurality of protrusions protruding from the surface of the base facing the display panel. The protrusions may have an identical or similar shape and be separated from one another by a predetermined distance. The protrusions may have a hemispherical shape.

The display panels may include a first substrate, a second substrate and a liquid crystal layer. The first substrate may be disposed under the protective film and include a first sensing electrode sensing the physical pressure. The second substrate may be disposed under the first substrate and include a pixel displaying an image and a second sensing electrode corresponding to the first sensing electrode. The liquid crystal layer may be interposed between the first substrate and the second substrate.

The display panel assembly may further include a polarizer. The polarizer may be disposed between the display panel and the protective film to polarize light passing through the display panel.

The protruding part may include a plurality of protrusions protruding from the surface of the base facing the display panel. The protrusions may be separated from the polarizer. Alternatively, the protrusions may make contact with the polarizer.

According to an embodiment of the present invention, there is provided a display apparatus. The display apparatus includes a display panel, a protective film and a backlight assembly. The display panel converts information input by a physical pressure into an electric signal and displays an image. The protective film includes a base disposed on the display panel and a protruding part protruding from a surface of the base facing the display panel and transfers the physical pressure from the exterior to the display panel. The backlight assembly is disposed under the display panel and provides the display panel with light.

The display panel may include a first substrate, a second substrate and a liquid crystal layer. The first substrate may be disposed under the protective film and include a first sensing electrode to sense the physical pressure transferred from the protective film. The second substrate may be disposed under the first substrate and include a pixel displaying an image and a second sensing electrode corresponding to the first sensing electrode. The liquid crystal layer may be interposed between the first substrate and the second substrate.

The display panel may detect a change in resistance caused by an electric contact between the first sensing electrode and the second sensing electrode. Alternatively, the display panel may detect a change in capacitance of a sensing capacitor defined by the first sensing electrode, the second sensing electrode and the liquid crystal layer.

According to one or more embodiments of the present invention, the display panel assembly and the display apparatus may have improved durability and sensitively detect a physical pressure applied by the user.

### BRIEF DESCRIPTION OF THE DRAWINGS

The above and other features and advantages of the embodiments of the present invention will become readily apparent by reference to the following detailed description when considered in conjunction with the accompanying drawings wherein:

FIG. 1 is a cross-sectional view illustrating a display apparatus in accordance with example embodiments of the present invention;

FIG. 2 is a cross-sectional view illustrating a display panel illustrated in FIG. 1 according to an embodiment;

FIG. 3 is a cross-sectional view illustrating the display panel illustrated in FIG. 2 according to an embodiment;

FIG. 4 is a perspective view illustrating a protective film illustrated in FIG. 1 according to an embodiment;

FIG. 5 is a cross-sectional view illustrating a display apparatus in accordance with example embodiments of the present invention; and

FIG. 6 is a cross-sectional view illustrating a display apparatus in accordance with example embodiments of the present invention.

### DETAILED DESCRIPTION

Embodiments of the present invention are described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it may be directly on, connected to or coupled to the other element or layer, or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be explained in detail with reference to the accompanying drawings.

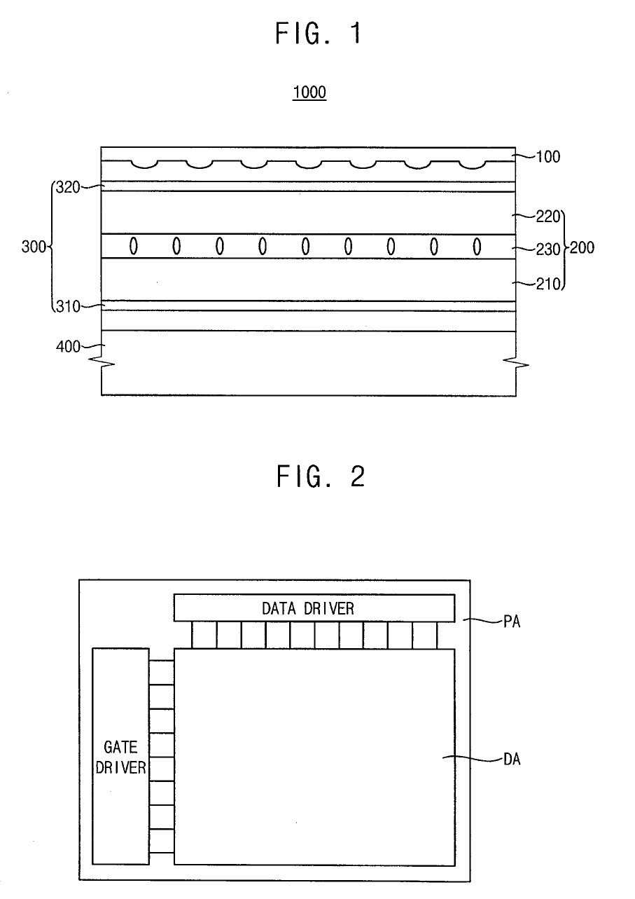

FIG. 1 is a cross-sectional view illustrating a display apparatus in accordance with example embodiments of the present invention.

Referring to FIG. 1, a display apparatus 1000 includes a display panel assembly and a backlight assembly 400. The display panel assembly includes a protective film 100 and a display panel 200.

The protective film 100 supplies a screen on which a user applies a physical pressure using a finger or a touching implement. The display panel 200 is disposed under the protective film 100 and receives the physical pressure via the protective film 100. The display panel 200 converts the physical pressure into an electrical signal to detect information concerning the position on which the physical pressure is applied. The display panel 200 displays an image based on the information. The backlight assembly 400 is disposed under the display panel 200 and provides the display panel 200 with light.

FIG. 2 is a cross-sectional view illustrating a display panel illustrated in FIG. 1 according to an embodiment.

Referring to FIG. 2, the display panel 200 includes a display area DA on which an image is displayed and a peripheral area PA surrounding the display area DA. The display panel 200 may include a liquid crystal display panel, a plasma display panel, etc.

In example embodiments of the present invention, the display panel 200 may be the liquid crystal display panel. When the display panel 200 is the liquid crystal display panel, the display panel 200 may include a first substrate 210, a second substrate 220 and a liquid crystal layer 230.

The first substrate 210 may include a plurality of pixels to display the image. Each of the pixels may include a thin film transistor which is a switching element, a gate line connected to a gate electrode of the thin film transistor, a source line connected to a source electrode of the thin film transistor, and a pixel electrode connected to a drain electrode of the thin film transistor. The pixel electrode may include a transparent conductive material so that light passes through the pixel electrode. For example, the pixel electrode may be formed of indium tin oxide (ITO) or indium zinc oxide (IZO). When the gate electrode of the thin film transistor receives a gate signal, the thin film transistor is turned on. When the thin film transistor is turned on, an image signal is applied to the pixel electrode via the source line, the source electrode and the drain electrode.

The second substrate 220 is opposite to the first substrate 210. The second substrate 220 includes a plurality of color filters to display colors and a common electrode formed on the color filters. The color filters may respectively correspond to the pixels and include a red color filter to display a red color, a green color filter to display a green color and a blue color filter to display a blue color. The common electrode is opposite to the pixel electrode and receives a common voltage. The common electrode may include a transparent conductive material. For example, the common electrode may be formed of indium tin oxide (ITO) or indium zinc oxide (IZO).

The liquid crystal layer 230 is disposed between the first substrate 210 and the second substrate 220 and includes liquid crystal molecules. An arrangement of the liquid crystal molecules may be changed according to an electric field generated between the pixel electrode and the common electrode. When the arrangement of the liquid crystal molecules is changed, an amount of light passing through the liquid crystal layer 230 may be changed so that the display panel 200 may display the image using the liquid crystal molecules.

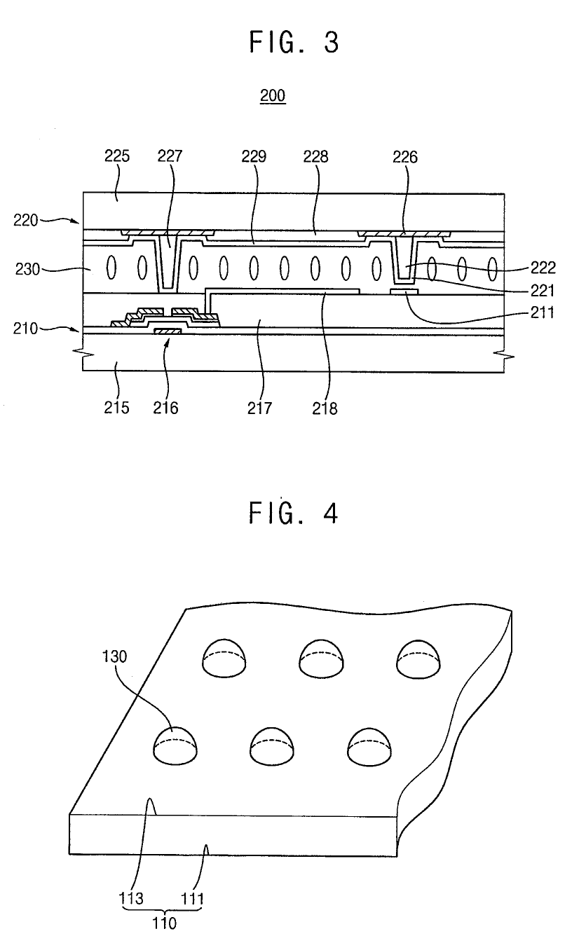

FIG. 3 is a cross-sectional view illustrating the display panel illustrated in FIG. 2 according to an embodiment.

Referring to FIGS. 2 and 3, the first substrate 210 includes first sensing electrodes 211 and the second substrate 220 includes second sensing electrodes 221. Each of the second sensing electrodes 221 is opposite to and separated from a corresponding one of the first sensing electrodes 211. The first sensing electrodes 211 may be uniformly formed in the display area DA of the display panel 200. For example, the first sensing electrodes 211 may be separated from one another by a predetermined distance. The second sensing electrodes 221 may be uniformly formed in the display area DA of the display panel 200. For example, the second sensing electrodes 211 may be separated from one another by the predetermined distance.

The first sensing electrodes 211 may be formed from the same layer as the pixel electrode on the first substrate 210. The second sensing electrodes 221 may be formed from the same layer as the common electrode on the second substrate 220. The second substrate 220 may include a supporting structure 222 formed between the second substrate 220 and the second sensing electrode 221. The supporting structure 222 supports the second sensing electrode 221 and reduces the spacing distance between the second sensing electrode 221 and the corresponding first sensing electrode 211. The supporting structure 222 may be formed from the same layer as a spacer 227 which maintains a cell gap between the first substrate 210 and the second substrate 220.

For example, a thin film transistor 216 may be formed on the first transparent substrate 215, and then an organic insulating layer 217 may be formed on the first transparent substrate 215 having the thin film transistor 216 thereon. A conductive material layer may be formed on the organic insulating layer 217, and then the conductive material layer may be etched to form the pixel electrode and the first sensing electrodes 211. In addition, a black matrix 226 is formed on a second transparent substrate 225, and then a color filter 228 is formed on the transparent substrate 225 having the black matrix 226 formed thereon. Then, the spacer 227 and the supporting structure 222 may be spontaneously formed on the second transparent substrate 225 having the black matrix 226 and the color filter 228. A transparent conductive layer may be formed on the second transparent substrate 225 having the spacer 227 and the supporting structure 222, and the transparent conductive layer may be etched to form the common electrode 229 and the second sensing electrodes 221.

The first sensing electrode 211 and the second sensing electrode 221 respectively receive voltages so that a reference voltage difference may be formed between the first and second sensing electrodes 211 and 221. When physical pressure is applied to a specific point of the second substrate 220, the second substrate 220 may be bent toward the first substrate 210 at the specific position of the second substrate 220 receiving the physical pressure. As a result, the second sensing electrode 221 of the second substrate 220 and the first sensing electrode 211 of the first substrate 210 may be electrically connected to each other at the specific point of the second substrate 220. When the first sensing electrode 211 and the second sensing electrode 221 are electrically connected to each other at the specific point, resistances of the first and second sensing electrodes 211 and 221 at the specific point may be changed, so that the reference voltage differences at the specific point may be changed. The display panel 200 may detect the change of the reference voltage difference and may analyze information concerning the specific point at which the first and second sensing electrodes 211 and 221 are electrically connected to each other. For example, the display panel 200 may detect a change of resistance caused by the electric contact of the first and second sensing electrodes 211 and 221 to analyze the information concerning the position at which the first and second electrodes 211 and 221 are electrically connected to each other.

Referring again to FIG. 1, the display panel assembly may further include a lower polarizer 310 and an upper polarizer 320. The lower polarizer 310 may be disposed between the display panel 200 and the backlight assembly 400. The upper polarizer 320 may be disposed between the protective film 100 and the display panel 200.

The lower polarizer 310 may have a first polarizing axis to polarize light in a first direction substantially parallel to the first polarizing axis. The upper polarizer 320 may have a second polarizing axis to polarize light in a second direction which is different from the first direction and substantially parallel to the second polarizing axis. For example, the first polarizing axis may be substantially perpendicular to the first polarizing axis.

The light generated by the backlight assembly 400 may be polarized by the lower polarizer 310 before the light is provided to the display panel 200. Light parallel to the second polarizing axis which passes through the display panel 200 may be emitted toward the exterior through the upper polarizer 320.

FIG. 4 is a perspective view illustrating a protective film illustrated in FIG. 1 according to an embodiment.

Referring to FIGS. 1, 2 and 4, the protective film 100 may include a base 110 and a protruding part 130. The base 110 may include a first surface 111 and a second surface 113. The first surface 111 may serve as a screen on which the user applies a physical pressure. The second surface 113 may be opposite to the first surface 111 and face the display panel 200. For example, the base 110 may have a rectangular plate shape.

The base 110 may include a transparent material since the user views the image displayed by the display panel 200 via the base 110. In addition, the base 110 may include a flexible elastic material since the base 110 is transformed based on the physical pressure applied by the user. In still another embodiment, the base 110 may include a strong material since the base 110 protects the display panel 200 from external impacts. For example, the base 110 may be formed of a transparent plastic material.

The base 110 may cover the display area DA of the display panel 200. For example, the base 110 may cover the display area DA of the display panel 200 because the user applies the physical pressure to the display area DA of the display panel 200 to input information to the display panel 200.

The protruding part 130 may include a plurality of protrusions 130. The protrusions 130 may protrude from the second surface 113 of the base 110. The protrusions 130 concentrate the physical pressure applied to the first surface 111 of the base 110 by the user and apply the concentrated physical pressure to the display panel 200. Therefore, the display panel 200 may sensitively detect the physical pressure applied to the first surface 111 of the base 110 and analyze information concerning the position at which the physical pressure is applied.

The protrusions 130 may have an identical or similar shape. Alternatively, the protrusions 130 may have different shapes to concentrate the physical pressure. In example embodiments of the present invention, the protrusions 130 may have a hemispherical shape. In example embodiments of the present invention, the protrusions 130 may have a polygonal pillar shape, such as a triangular prism shape, a square pillar shape, etc., or a combination or modification thereof.

The protrusions 130 may have an identical or similar height with respect to the second surface 113 of the base 110, so that the physical pressure applied to the first surface 111 of the base 110 may be uniformly transferred to the display panel 200. Alternatively, the protrusions 130 may have different heights with respect to the second surface 113 of the base 110. For example, some protrusions 130 formed in edges of the base 110 may have a larger height than that of other protrusions 130 formed in a center portion of the base 110, so that some protrusions 130 formed in the edges of the base 110 sensitively transfer the physical pressure to the display panel 200.

The protrusions 130 may be uniformly formed on the second surface 113 of the base 110. For example, the protrusions 130 may be separated from one another by a predetermined distance on the second surface 113 of the base 110.

In example embodiments of the present invention, the protrusions 130 may be separated from the upper polarizer 320. When the protrusions 130 are separated from the upper polarizer 320, the physical pressure applied to the first surface 111 of the base 110 may be amplified to be transferred to the display panel 200.

In example embodiments of the present invention, the protrusions 130 may make contact with the upper polarizer 320. When the protrusions 130 make contact with the upper polarizer 320, the physical pressure applied to the first surface 111 of the base 110 may be promptly transferred to the display panel 200.

When the protrusions 130 are formed on the second surface 113 of the base 110, an upper surface of the upper polarizer 320 facing the second surface 113 of the base 110 may be flat. When the second surface 113 of the base 110 is flat, the second surface 113 of the base 110 and the upper surface of the polarizer 320 adhere to each other to generate stains. Therefore, in the embodiments of the present invention, the stain may be prevented, because the protrusions 130 are formed on the second surface 113 of the base 110 facing the upper surface of the upper polarizer 320.

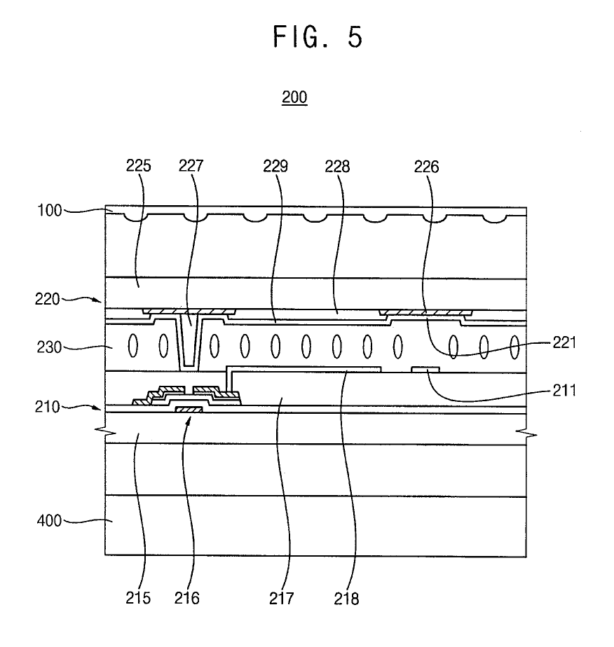

FIG. 5 is a cross-sectional view illustrating a display apparatus in accordance with example embodiments of the present invention. The example embodiments of the present invention concerning FIG. 5 have elements substantially the same as those illustrated above, except for a display panel. Thus, any repetitive explanation concerning other elements except for the display panel will be omitted.

Referring to FIG. 5, a display panel includes a first substrate 210, a second substrate 220 opposite to the first substrate 210, and a liquid crystal layer 230 interposed between the first and second substrates 210 and 220.

The first substrate 210 includes first sensing electrodes 211 and the second substrate 220 includes second sensing electrodes 221. Each of the second sensing electrodes 221 is opposite to and separated from a corresponding one of the first sensing electrodes 211. When a pixel electrode 218 is formed on the first substrate 210, the first sensing electrodes 211 may be formed from a same layer as the pixel electrode 218. When a common electrode 229 is formed on the second substrate 220, the second sensing electrodes 221 may be formed a same layer as the common electrode 229.

A sensing capacitor may be defined by the first sensing electrode 211, the second sensing electrode 221 and the liquid crystal layer 230 interposed between the first and second sensing electrodes 211 and 221. The sensing capacitor may receive a reference voltage.

When a physical pressure is applied to a specific point of the second substrate 220, the second substrate 220 is bent toward the first substrate 210 at the specific point. As a result, a distance between the first and second sensing electrodes 211 and 221 may be reduced. When the distance between the first and second sensing electrodes 211 and 221 is reduced, the capacitance of the sensing capacitor may increase. When the capacitance of the sensing capacitor is reduced, the reference voltage applied to the sensing capacitor may be reduced because electric charges charged in the sensing capacitor are not changed even though the capacitance of the sensing capacitor increases. The display panel 200 may detect the change of the reference voltage and may analyze information concerning the specific position receiving the physical pressure. For example, the display panel 200 may detect a change in capacitance of the sensing capacitor and analyze the information concerning the specific position receiving the physical pressure.

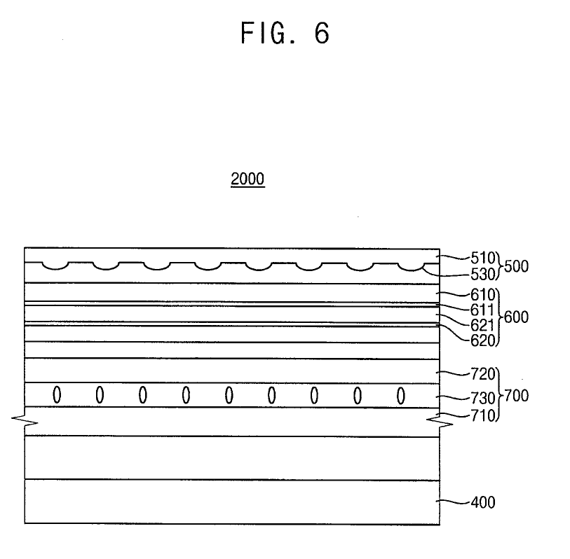

FIG. 6 is a cross-sectional view illustrating a display apparatus in accordance with example embodiments of the present invention. The example embodiments of the present invention concerning FIG. 6 have elements substantially the same as those illustrated above, except for an information input part and an image display part. Thus, any repetitive explanation concerning other elements except for the information input part and the image display part will be omitted.

Referring to FIG. 6, a display panel 2000 includes an information input part 600 and an image display part 700.

The information input part 600 converts information input by a physical pressure into an electric signal. For example, the information input part 600 may include an upper substrate 610 and a lower substrate 620, which is opposite to the upper substrate 610. The upper substrate 610 may include a plurality of first sensing electrodes 611 uniformly formed thereon. The lower substrate 620 may include a plurality of second sensing electrodes 621 respectively corresponding to the first sensing electrodes 611. The physical pressure applied to the upper substrate 610 may change voltages applied to the first and second sensing electrodes 611 and 621. The information input part 600 may detect changes in voltages applied to the first and second sensing electrodes 611 and 621 and analyze information concerning a specific position at which the physical pressure is applied. The information input part 600 may generate electric signals based on the analysis of the information concerning the specific position at which the physical pressure is applied.

A protective film 500 is disposed on the information input part 600. The protective film 500 directly receives the physical pressure and transfers the received physical pressure to the information input part 600. In example embodiments of the present invention, the protective film 500 may include a base 510 and a protruding part 530. The base 510 may be disposed on the information input part 600 and include a first surface and a second surface. The first surface of the base 510 may receive the physical pressure applied by the user. The second surface of the base may be opposite to the first surface of the base 510 and face the information input part 600. The protruding part 530 may include a plurality of protrusions 530 protruding from the second surface of the base 510. The protrusions 530 may have the same shape and/or a same height. The protrusions 530 may be uniformly formed on the second surface of the base 510. For example, the protrusions 530 may be separated from one another by a predetermined distance on the second surface of the base 510. The protrusions 530 may be separated from the information input part 600. Alternatively, the protrusions 530 may make contact with the information input part 600.

The image display part 700 receives the electric signals generated from the information input part 600 to display images. For example, the image display part 700 may include a liquid crystal display panel. When the image display part 700 includes the liquid crystal display panel, the image display part 700 may include a first substrate 710, a second substrate 720 and a liquid crystal layer 730. The image display part 700 may have components and operations that are substantially the same as those of the display panel discussed above, except that the image display part 700 does not detect the physical pressure by itself. Thus, any further repetitive explanation concerning the image display part 700 will be omitted.

According to example embodiments of the present invention, the display panel assembly and the display apparatus include a protective film having the base and the protruding part formed on a surface of the base. Thus, the display panel assembly and the display apparatus may have an improved durability and sensitively detect the physical pressure applied by the user.

The foregoing embodiments are illustrative of the present invention and are not to be construed as limiting thereof. Although a few example embodiments of the present invention have been described, those skilled in the art will readily appreciate that many modifications are possible in the example embodiments without materially departing from the novel teachings and advantages of this disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims, with equivalents of the claims to be included therein.

What is claimed is:

1. A display panel assembly, comprising:
a display panel adapted to convert information input by a physical pressure into an electric signal and to display an image; and
a protective film including a base disposed on the display panel and a protruding part protruding from a surface of the base facing the display panel, and adapted to transfer the physical pressure from an exterior to the display panel.

2. The display panel assembly of claim 1, wherein the base comprises a transparent plate.

3. The display panel assembly of claim 2, wherein the base comprises a plastic material.

4. The display panel assembly of claim 1, wherein the protruding part comprises a plurality of protrusions protruding from the surface of the base facing the display panel.

5. The display panel assembly of claim 4, wherein the protrusions have a similar shape and are separated from one another by a predetermined distance.

6. The display panel assembly of claim 5, wherein the protrusions have a hemispherical shape.

7. The display panel assembly of claim 1, wherein the display panel comprises:
a first substrate disposed under the protective film, the first substrate including a first sensing electrode sensing the physical pressure;
a second substrate disposed under the first substrate, the second substrate including a pixel displaying an image and a second sensing electrode corresponding to the first sensing electrode; and
a liquid crystal layer interposed between the first substrate and the second substrate.

8. The display panel assembly of claim 7, wherein the display panel detects a change in resistance caused by an electric contact between the first sensing electrode and the second sensing electrode, or detects a change in capacitance of a sensing capacitor defined by the first sensing electrode, the second sensing electrode and the liquid crystal layer.

9. The display panel assembly of claim 7, wherein the display panel comprises a display area displaying the image and a peripheral area surrounding the display area, and the base covers the display area of the display panel.

10. The display panel assembly of claim 7, further comprising a polarizer disposed between the display panel and the protective film to polarize light passing through the display panel.

11. The display panel assembly of claim 10, wherein the protruding part comprises a plurality of protrusions protruding from the surface of the base facing the display panel, and the protrusions are separated from the polarizer.

12. The display panel assembly of claim 10, wherein the protruding part comprises a plurality of protrusions protruding from the surface of the base facing the display panel, and the protrusions make contact with the polarizer.

13. The display panel assembly of claim 12, wherein a surface of the polarizer making contact with the protrusions is flat.

14. The display panel assembly of claim 1, wherein the display panel comprises:
an information input part disposed under the protective film, the information input part adapted to convert the information input by the physical pressure into the electric signal; and
an image display part disposed under the information input part, the image display part adapted to receive the electric signal from the information input part and display the image in response to the electric signal.

15. The display panel assembly of claim 14, wherein the protruding part comprises a plurality of protrusions protruding from the surface of the base facing the display panel, and the protrusions are separated from the information input part.

16. The display panel assembly of claim 14, wherein the protruding part comprises a plurality of protrusions protruding from the surface of the base facing the display panel, and the protrusions make contact with the information input part.

17. A display apparatus comprising:
a display panel adapted to convert information input by a physical pressure into an electric signal and to display an image;
a protective film including a base disposed on the display panel and a protruding part protruding from a surface of the base facing the display panel, and adapted to transfer the physical pressure from an exterior to the display panel; and
a backlight assembly disposed under the display panel, the backlight assembly providing the display panel with light.

18. The display apparatus of claim 17, wherein the display panel comprises:
a first substrate disposed under the protective film, the first substrate including a first sensing electrode to sense the physical pressure transferred from the protective film;
a second substrate disposed under the first substrate, the second substrate including a pixel displaying an image and a second sensing electrode corresponding to the first sensing electrode; and
a liquid crystal layer interposed between the first substrate and the second substrate.

19. The display apparatus of claim 18, wherein the display panel detects a change in resistance caused by an electric contact between the first sensing electrode and the second sensing electrode.

20. The display apparatus of claim 18, wherein the display panel detects a change of capacitance of a sensing capacitor defined by the first sensing electrode, the second sensing electrode and the liquid crystal layer.
